(19) United States
(12) Patent Application Publication
(10) Pub. No.: US 2020/0273077 A1
(43) Pub. Date: Aug. 27, 2020

(54) RATING SYSTEM AND METHOD

(71) Applicants: Chris GARDNER, Gainesville, FL (US); Dennis PLUNKETT, Gainesville, FL (US)

(72) Inventors: Chris GARDNER, Gainesville, FL (US); Dennis PLUNKETT, Gainesville, FL (US)

(21) Appl. No.: 16/799,139

(22) Filed: Feb. 24, 2020

Related U.S. Application Data
(60) Provisional application No. 62/809,015, filed on Feb. 22, 2019.

(51) Int. Cl. G06Q 30/02; G06F 16/955

(52) U.S. Cl. CPC G06Q 30/0282; G06F 16/9558; G06F 16/9554

(57) ABSTRACT

A business rating system is provided in embodiments herein, including a substrate comprising a second communicative component, a machine comprising a processor and a first communicative component, wherein said first and second communicative components are communicatingly connected. The system may further include a tangible, non-transitory computer readable medium having program instructions executed by the processor, including receiving data, said data comprising url information related to a first webpage, opening a web browser on the machine, and directing the web browser to the first webpage url, wherein the first webpage redirects to a second webpage, the second webpage comprising a webpage for receiving rating input related to the business.

### CROSS-REFERENCE TO RELATED APPLICATIONS

This application claims the benefit of U.S. Provisional Application No. 62/809,015 filed Feb. 22, 2019, which is incorporated herein by reference in its entirety.

### BACKGROUND

QR (quick response) codes are two dimensional codes, a type of matrix barcode, which can be decoded as a digital image. These barcodes are machine readable optical labels which often contain information about the item to which they are attached. These barcodes provide data related to a website, in some cases. They typically include black squares arranged on a square grid on a white background, which may be read by an imaging device, including a camera. The required data is extracted from patterns that are present in both vertical and horizontal components of the image.

Rating cards are often used to engage connections between people and businesses, and to facilitate the rating of those business by the recipient of the card, while providing information related to a particular business or individual. However, the uses of QR codes on rating cards is currently limited. Oftentimes, rating cards are scanned with a camera to translate printed words into digital data via OCR (optical character recognition) software. Most OCR software has a high error rate in translating the information on cards where various fonts and designs are printed.

Lastly, businesses benefit from online ratings by customers on their websites to rate the business, educate others about the business and whether its services are satisfactory, perhaps even impact its online visibility and enhance its web-presence. However, obtaining compliance from the public in rating businesses is tedious and time-consuming, often requiring follow up when customers fail to follow through. Therefore, a method for simplifying the process of rating businesses may increase compliance.

### SUMMARY

Aspects of the present invention relates to methods and systems for digitizing printed information on a substrate and coupling that with the ability to access business information, in some examples, through wireless communication methods for the purpose of providing a system to increase compliance amongst users in rating businesses, in one non-limiting example.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 is a plan view of an embodiment of a substrate described herein.

FIG. 2 is an embodiment of a method described herein.

FIG. 3 shows a plan view of a system according to an embodiment herein.

### DETAILED DESCRIPTION

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. Furthermore, to the extent that the terms “including,” “includes,” “having,” “has,” “with,” or variants thereof are used in either the detailed description and/or the claims, such terms are intended to be inclusive in a manner similar to the term “comprising.” The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable.

The terminology used herein is for the purpose of describing particular embodiments only and is not intended to be limiting. As used herein, the singular forms “a,” “an,” and “the” are intended to include the plural forms as well, unless the context clearly indicates otherwise these terms do not denote a limitation of quantity, but rather denote the presence of at least one of the referenced item. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order, quantity or importance, but rather the terms first, second, etc., are used to distinguish one element from another.

### Overview

A method and system for simplifying the process of rating and ranking businesses and allowing customers to easily access a business website has been found to be beneficial herein. Typically, a business would ask a customer to leave a review on an online platform like Google®, for example. The customer would proceed by opening a web browser, and searching for the business. In many instances if the business name is misspelled and in the first few hits of the search the customer cannot find the business, that business may lose the customer's review. If the customer is able to identify the correct business, customer must then click a number of links to access the rating page. In one particular example, the customer must click on a small link to rate the business at the webpage provided by the business to the customer for rating, and then the customer must take an additional step to click on a link to write a review. In these multitude of steps customers may get frustrated, lose interest, be unable to access the page, and the review may never reach the company website as a result. Users prefer quick, efficient methods of delivering information, and business benefit from direct, efficient methods of communication. The rating process is no different.

Consequently, in order to provide a method to enable a customer, or user, to more efficiently rate a business and to encourage compliance with ratings, in one embodiment a wireless communicative system may be used to communicate between two or more components of a system. In one example, a first communicative component may acquire information from a second communicative component. In one non-limiting example, the first and second communicative components may be in close range to one another to take advantage of short-range communication technology for information exchange. Close range may include within 40 feet or less in one embodiment. In another embodiment, close range may include within one foot or less of one another. In still another embodiment, close range may include a range of between 1-10 cm from one another, for example. In at least one example, the first communicative component may include a reader, and the second communicative component may include a barcode, tag, or chip, for example. When placed in close range of one another, the reader may obtain information from the barcode, tag, or chip.

In one non-limiting embodiment the first communicative component may include a QR code reader, and the second communicative component may include a QR code displayed on a substrate.

In another non-limiting embodiment, the first communicative component may include an RFID (radio frequency identification) reader, and the second communicative component may include an RFID tag. RFID is one example of a type of wireless communication that may be used to communicate information between two components of the system. Moreover, RFID is, more specifically, one type of nearfield communication (NFC) that may be used to communicate information or data between two components of the system.

In one embodiment, the first communicative component may include a QR code reader, and the second communicative component may include a QR code (or other barcode), which may be embedded on a substrate, such as a rating card, for example, provided to a user by a business to be rated. The QR code would be scanned by a QR code reader, in one non-limiting example as described herein and would direct the user to a specific URL, in some instances a second webpage, enabling the user to provide a customer review. The specific URL may include, for example, the Google® search URL, which includes the business identification. This would allow the user to skip the steps in between which cause frustration or disinterest of the user, results in wasted time, and often result in errors and lack of adherence. In other examples, communication between the first communicative component and the second communicative component may direct the user to a specific social media page.

Between the communication between the first communicative component and the second communicative component, in one non-limiting example by scanning of the QR code with a QR code reader, and accessing the second webpage, which may include the rating webpage (whether the Google® search rating webpage or social media page for rating, or other) for the business affiliated with the rating substrate, the process and system would include a first webpage, in one embodiment. The first webpage may be accessed upon communication between the first communicative component and the second communicative component (i.e., scanning the QR code by the QR code reader, for example, or placing the RFID reader in sufficiently close proximity to the RFID tag, in another example). In some instances, the first webpage may automatically redirect to the second webpage. In some embodiments, an administrator of the system may control the access to the first webpage and/or the second webpage. In one example, the administrator can selectively stop the redirect from the first webpage to the second webpage, or allow access to only the second webpage directly following communication between the first communicative component and the second communicative component, foregoing access to the first webpage altogether in one non-limiting embodiment.

In one embodiment, the second communicative component may be linked to a web address, which may redirect on a portable terminal to a website. Access to the website for providing a rating occurs with a first communicative component, such as a machine for scanning, reading, and decoding the QR code or other barcode or an RFID reader or other reader in non-limiting embodiments. In one example, the first communicative component may include a Smartphone including NFC capability, said Smartphone having a camera including a QR code decoder, in one example. In one embodiment, the Smartphone camera may allow access to the rating webpage or social media account of the business by hovering the Smartphone camera over the second communicative component, which may include a QR code embedded, printed, or displayed on a substrate (i.e., a rating card). This may allow access to a first webpage, wherein the first webpage may redirect to a second webpage (i.e., the rating page for the business). In some embodiments, the user of the system and method may not see the first webpage and may not know the user is being redirected to the second webpage from a first webpage. The connection may be seamless between the two websites.

The second webpage may typically include the rating page for the business, for example, the Google® search page or a business social media page, in non-limiting examples, wherein businesses can be rated by the public. On this page, access to information about the business may be provided. In addition, as aforementioned, a rating of the business may be made by the user at the second webpage. The process described herein allows for selective access to the business through a redirect page, in one embodiment, i.e., the first webpage linked to the second communicative component (for example QR code), which then redirects to the second webpage.

In an alternative embodiment, information may be provided on the first webpage, and a link to the second webpage may be accessed via a link on the first webpage, for example. Therefore, before providing access to the second webpage, a user/viewer would gain access to the first webpage with data or information thereon, which may include advertising information. The first webpage would be directly linked to the second communicative component on or in the substrate, such as the QR code.

In yet another embodiment, the url for the second webpage may be directly accessed by placing the first communicative component within the required proximity of the second communicative component, or in one non-limiting embodiment, by scanning a QR code on the substrate with a QR code reader (i.e., such as a Smartphone camera) in order to provide direct access to a ratings page for a business, for example, without requiring access through a first website.

For ease of access and distribution, the substrate having the second communicative component may include but are not limited to, a rating card affiliated with a business or an event, in some non-limiting examples. In one specific, non-limiting example, businesses may provide a rating card including the QR code, wherein the QR code is linked directly to the first webpage. The first webpage may be specific to the business from which the rating card originated, in some embodiments. Therefore, on the back end of the process, access to the second webpage, which would include the website to rate the business, or another website, in non-limiting examples, would occur via access through the first webpage redirecting to the second webpage. As aforementioned, in some instances the first webpage will automatically redirect to the second webpage. In other examples, the first webpage may include a link to access the second webpage directly through the first webpage. In yet other examples, the first webpage may include information, advertisements, or other data related to or unrelated to the business to be rated at the second webpage. Access to the second webpage via the first webpage, and ultimately by way of the first communicative and second communicative components can be controlled by the administrator.

In at least some embodiments described herein, NFC (near field communication) methods and systems are used to communicate between components of the system described herein. Near field communication may include RFID (Radio-Frequency Identification) or Bluetooth® technology. The communication between components of the device may occur by way of a barcode or QR code and barcode/QR code reader, wherein the reader obtains information from the code upon accessing the code.

Compared to other wireless communication methods, NFC may operate only within a very limited distance (within 15 cm in some examples) and encryption technology may be applied thereto to increase security level of NFC communication and transfer of data. Accordingly, when used in combination with other high-speed wireless communication methods, such as 3G or Wi-Fi, communication between devices via NFC may be performed with a higher efficiency and security, in some examples. For example, when NFC and Bluetooth technology are combined, NFC may be used in connecting terminals or devices (authorization) and Bluetooth may be used in data transmission between the devices or terminals to thereby enable more efficient communication between the devices.

The term “communicatingly connected” as used herein includes a wired or wireless connection. The wireless connection includes but not limited to NFC, RFID, Bluetooth®, Wi-Fi, or other connections known to those skilled in the art.

NFC is a contactless short-range wireless communication standard between electronic devices within a short distance of 10 cm with low power consumption by using a frequency of 13.56 MHz, for example. A data transfer rate of an NFC system is 424 Kbps, for example, and an NFC system has excellent security due to high proximity and encryption technology. NFC forgoes a complicated pairing process for recognition of devices but allows devices to recognize one another within 1/10 second or less, for example. In particular, NFC is a smart card type contactless wireless communication technology where radio frequency identification (RFID) technology is utilized. In addition, NFC builds upon RFID technology by allowing two-way communication, as compared to smart cards, which have only one-way communication, and has a relatively large memory storage space and offers more variety of services.

In detail, NFC is a wireless communication method in which data is directly exchanged between a first communicative component and a second communicative component according to embodiments described herein, for example. In one embodiment, the communication occurs between the NFC device 10 and the NFC device 20, without using a communication network, and is a type of RFID method. A wireless communication method using RFID may be classified according to frequencies used. For example, RFID at 13.56 MHz is mainly used for smart cards, such as transit cards or entrance cards, and RFID at 900 MHz is used mainly for logistics. NFC corresponds to RFID which, like smartcards, uses a frequency of 13.56 MHz. However, unlike smartcards, which allow only one-way communication, NFC allows two-way communication. Accordingly, NFC is different from smart cards, which function merely as a tag that stores particular information and transmits the same to a reader. NFC communication allows a tag function according to necessity but also supports a function of recording information on the tag, and may be used in peer to peer (P2P) data exchange between components in which NFC is provided. Other communication methods described in embodiments herein include Wi-Fi Bluetooth, ZigBee, among others known in the art. As aforementioned, NFC may operate at a distance within about 20 cm or less, most preferably at about 10 cm or less. Unlike Bluetooth or Wi-Fi etc., which allow communication in about several to several tens of meters, NFC allows communication only within an extremely short distance. In addition, NFC may be used in conjunction with other wireless communication methods, such as Bluetooth, ZigBee, etc.

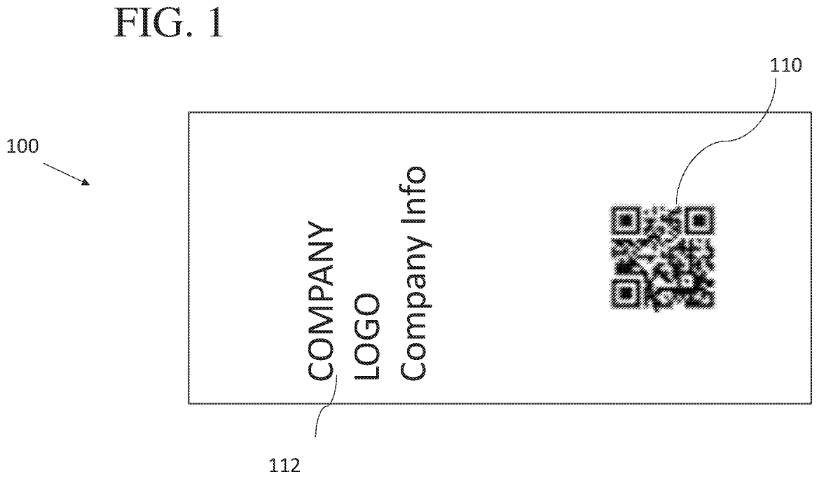

FIG. 1 provides a plan view of a substrate 100 including a second communicative component 110. In one example, the second communicative component 110 includes a QR code. Additional data 112 may be provided on or in the substrate, in one non-limiting embodiment. Additional data may be displayed including business information or other contact information. The substrate 100 may additionally, in a non-limiting embodiment include a signal output component such as a speaker, one or more visual outputs including lights, for example, a tactile component such as a vibratory element, for example. The substrate 100 may further include a microphone, and optionally may include a sensor. The sensor may include an accelerometer, or a contact, proximity, light, temperature, fluid, or other sensor known in the art used to detect information received by the substrate 100.

A near field communication component is provided and may provide for communication to or from a device or machine 118 (such as an electronic device, in one example, a Smartphone) by RFID, for example, as described herein. As aforementioned, an RFID reader may be provided in the device (shown as a first communicative component 110) and second communicative component 114, or RFID tag, in one example, can be associated with a substrate.

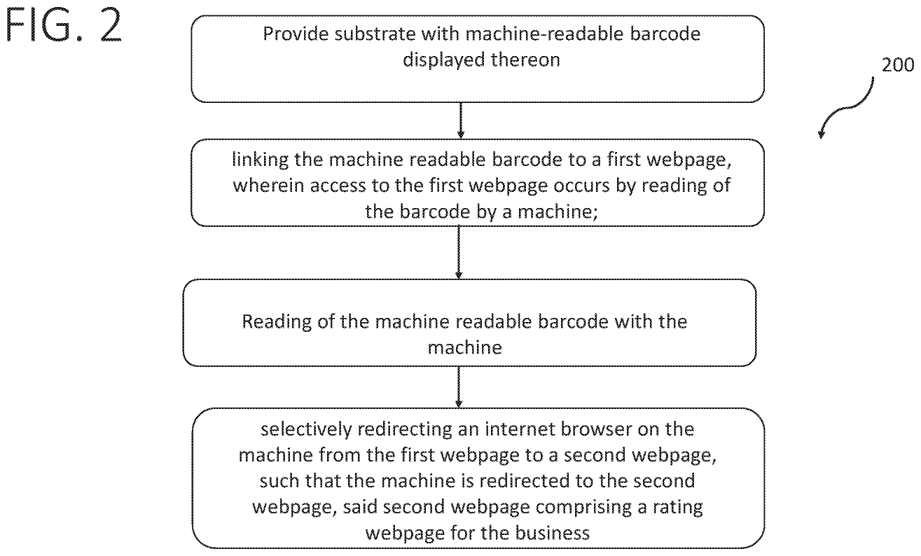

FIG. 2 is a method of selectively controlling access to a rating page for a business, in one embodiment for providing direct access to a rating page to facilitate rating by a customer. In a first step, a user is provided with a substrate having a machine-readable barcode displayed thereon. In some examples the machine-readable barcode comprises a QR code. The QR code is linked to a first webpage, wherein access to the first webpage occurs by reading of the barcode by a machine configured to decode the barcode. One example of a machine for decoding a barcode is a Smartphone having a camera and a QR code decoder. By hovering a camera of the Smartphone over the QR code, for example, a user is directed through a first webpage to a second webpage which includes the rating page for that business (i.e. the Google® places ID, for example).

In some non-limiting embodiments, the first webpage may automatically redirect to a second webpage. An administrator or controller of the system and method can control whether the first webpage redirects to the second webpage, therefore providing a profitable business plan for the administrator. The administrator may also control what, if any content, is placed on the first webpage. In some examples described herein the second webpage is a company rating website, such as, for example, the Google® rating webpage featuring the business. In one particular embodiment, the substrate comprises a rating card. The rating card may also include other data related to the business displayed thereon in some examples, as is provided on business cards, or marketing or promotional material, generally. The url for the first webpage, accessible via the QR code is specific to the business to be rated, in some embodiments, i.e., it may redirect to the Google® or other ratings page for that business, or to a social media page for the business.

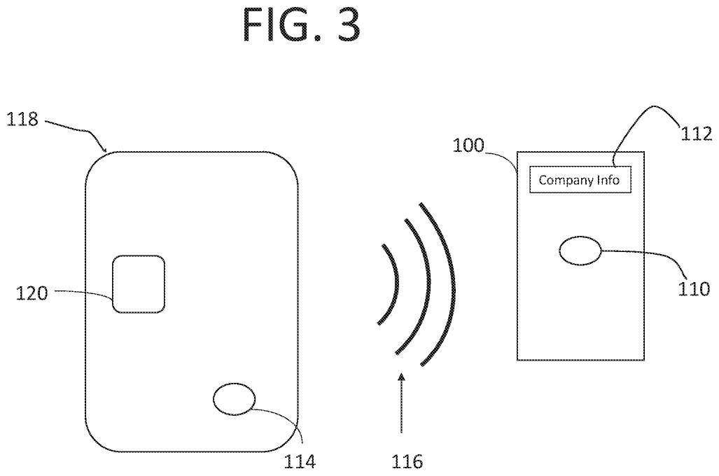

FIG. 3 shows a plan view of a system according to an embodiment herein including a machine 118 comprising a second communicative component 114, communicatingly connected 116 with a substrate 100 comprising a first communicative component 110. The machine (or device) 118 comprises a processor 120, and may further optionally comprise other sensors or signal input or output components as known in the art, including microphones, accelerometers, speakers, and the like. The substrate 100 may also include such sensors, signal output or signal input components as known in the art and as described herein.

In yet a further embodiment, a tangible, non-transitory computer readable medium having program instructions executed by the processor to perform the methods in the embodiments described, is provided herein.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. As a non-limiting example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 7.

What is claimed is:

1. A method for controlling access to a rating webpage for a business, comprising:
providing a substrate comprising a second communicative component;
linking the second communicative component to a first webpage, wherein access to the first webpage occurs by access to the second communicative component by communication between a first communicative component and the second communicative component, wherein the first communicative component is associated with a machine;
selectively redirecting from the first webpage to a second webpage, such that the machine is redirected to the second webpage;
wherein the second webpage comprises a business rating webpage.

2. The method of claim 1, wherein the second webpage comprises a Google® search url comprising a places identification.

3. The method of claim 1, wherein the second page comprises a social media webpage for a business.

4. The method of claim 1, wherein the substrate comprises a rating card.

5. The method of claim 1, wherein the first webpage is specific to the business.

6. The method of claim 1, further comprising wherein the second webpage comprises a url comprising the Google® places ID for the business.

7. The method of claim 1, wherein the first webpage comprises advertising material.

8. The method of claim 1, wherein the machine comprises a Smartphone, wherein said camera comprises the first communicative component for accessing information provided via the second communicative component.

9. The method of claim 1, wherein the first communicative component and the second communicative component communicate via wireless communication.

10. The method of claim 9, wherein the first and second communicative components communicate via NFC.

11. The method of claim 1, wherein the second communicative component comprises a machine-readable barcode.

12. The method of claim 11, wherein the machine readable barcode comprises a QR code.

13. The method of claim 11, wherein the first communicative component comprises a machine for reading a barcode.

14. The method of claim 1, wherein the machine comprises a portable electronic device.

15. A method for controlling access to a business rating webpage, comprising:
providing a substrate comprising a machine-readable barcode;
linking the machine-readable barcode to a first webpage;
providing a link to a second webpage on the first webpage wherein said first webpage comprises data, and wherein said second webpage comprises the business rating webpage.

16. The method of claim 15, wherein the machine-readable barcode is a QR code.

17. The method of claim 15, wherein the machine is a Smartphone comprising a camera for interfacing with the barcode, said Smartphone capable of decoding the barcode.

18. A business rating system, comprising:
a substrate comprising a second communicative component;
a machine comprising a processor and a first communicative component, wherein said first and second communicative components are communicatingly connected;
a tangible, non-transitory computer readable medium having program instructions executed by the processor, comprising:
receiving data, said data comprising url information related to a first webpage,
opening a web browser on the machine,
directing the web browser to the first webpage url, wherein the first webpage redirects to a second webpage, said second webpage comprising a webpage for receiving rating input related to the business.

19. The business rating system of claim 18, wherein the second communicative component comprises a machine-readable barcode, and the first communicative component is configured to decode the barcode.
